(19) United States
(12) Patent Application Publication
(10) Pub. No.: US 2016/0340963 A1
(43) Pub. Date: Nov. 24, 2016

(54) REUSABLE DOOR COVERING DEVICE AND METHOD

(71) Applicant: Jerry Loch, Green Bay, WI (US)

(72) Inventor: Jerry Loch, Green Bay, WI (US)

(21) Appl. No.: 15/161,656

(22) Filed: May 23, 2016

Related U.S. Application Data
(60) Provisional application No. 62/164,862, filed on May 21, 2015.

(51) Int. Cl. E06B 3/70; B05B 15/04; E06B 9/06

(52) U.S. Cl. CPC E06B 3/7001; E06B 9/0692; B05B 15/045

(57) ABSTRACT

A reusable door covering device provides a continuous sheet of protective material having an elastically expandable perimeter which is expanded to lengthen the perimeter and then contracted to shorten the perimeter, allowing the sheet to be used with a wide variety of door sizes. The sheet and its elastically expandable perimeter is the primary means for protecting the door. To prevent the passage of forced air into the space between the door and the sheet of protective material, the door covering device comprises at least one band of material that can be used to secure at least two sides of the door covering device on the side opposite that to which the door covering device is applied. The perimeter of the door covering device also includes additional sealing means for allowing the perimeter to be sealed about the hinge hardware used to hang the door.

This application claims the benefit and priority of United States Provisional Patent Application No. 62/164,862 filed May 21, 2015.

### FIELD OF THE INVENTION

This invention relates generally to the art and trade of building construction and to devices and methods that are used in building construction. More specifically, the present invention relates to a reusable door covering device that can be removably attached to a door so as to protect one side of the door from paint or other coatings that may be sprayed or applied to wall surfaces that are immediately adjacent to and around such door and door jamb.

### BACKGROUND OF THE INVENTION

It is well known in the building construction trade that doors and door jambs are regularly installed in newly built and renovated residential and commercial structures. Doors and their associated door jambs often arrive on site as a pre-fabricated unit, sometimes called a “pre-hung” door. The door jambs are inserted into rough doorways and then nailed into place. However, hanging a door properly is more difficult that it might appear and is considered a true measure of carpentry skill. Once installed, the door should consistently capture within its latch when closed and also clear its jamb and swing effortlessly on its hinges when opened. This calls for fine tolerances, hence the need for skillful carpentry.

Once installed and determined to be plumb, the trim or casing for the door jamb can be installed at a later time. In the interim, it is possible that the walls surrounding the doorway are spray painted or coated with sand finish texture paint using a compressed-air sprayer. This avoids any paint or coating being deposited onto the trim or casing, around the doorway and elsewhere in the area. One problem with this installation sequence is that the door itself is then exposed and a part of the door will be painted or coated unless it is removed from its hinges and relocated away from wall painting and coating activity. However, removal of the doors for this purpose slows down the overall construction process.

In the experience of these inventors, the only other suitable substitute for such door removal is to use some sort of improvised covering that is removably placed over the door and then taped into place. This process is about as inefficient and time consuming as removing the doors in the first instance. That is, by the time the covering is placed about the door (which is never done uniformly and or consistent protection) and then removed, a worker could have removed the door hinge pins, removed the door, relocated the door, replaced the door to the jamb associated with it and then reinserted the hinge pins, such is equally time-consuming and inconvenient.

The other problem encountered by use of an improvised door covering as described above is that it tends to “blow away” from the door, thereby exposing parts of the door to paint droplets. That is, paint or other wall coatings are typically deposited onto the walls surrounding the door jamb through the use of pressurized air which delivers paint droplets onto the walls by means of the compressed-air sprayer. If not adequately sealed, this forced air, together with its paint droplets or wall coating droplets, can be forced into the space between the door and the covering, thereby depositing such paint or coating droplets onto the door, which then needs to be removed from the door.

Accordingly, it would be a desirable objective to innovate a door covering device or structure and method for allowing such doors to remain hung and within the door jamb while such painting or other coating is applied to the walls surrounding the door and jamb without any paint or coating being deposited onto the door. It would also be a desirable objective to innovate such a door covering device that comprises an elastically expandable perimeter such that the door covering device can wrap itself about the door, as well as being able to wrap around other doors of other sizes. That is, the elastically expandable perimeter could be expanded to lengthen the perimeter and then contracted to shorten it. Further, it would also be a desirable objective to innovate such a door covering device and method that would allow such covering device to be inexpensive to fabricate, easy to fabricate, easy to use and also be reusable from one door to the next.

### SUMMARY OF THE INVENTION

The reusable door covering device and method of the present invention has obtained these objectives. It provides for a door covering device comprising a continuous sheet of protective material having a perimeter. That perimeter is greater than the perimeter of the door with which the door covering device would be used. Further, the perimeter of the sheet is expandable. The elastically expandable perimeter could be expanded to lengthen the perimeter and then contracted to shorten the perimeter, which allows the sheet to be used with a wide variety of door sizes. The sheet and its elastically expandable perimeter is the primary means for protecting the door.

To prevent the passage of forced air into the space between the door and the sheet of protective material, such as when the surrounding walls are being spray painted, the paint being deposited by droplets forced by pressurized air, the door covering device further comprises a secondary means for protecting the door. This protection is provided by means of at least one band of material that can be used to secure at least two sides of the door covering device on the side opposite that to which the door covering device is applied. This band of material can be formed as two pieces of strap or band material, one end of which is attached or secured to the sheet perimeter and another end having hook and loop fastening capabilities, such as that which is provided by a VELCRO® fastener (VELCRO is a registered mark of Velcro Corporation B.V.). In this way, the hook and loop portions of the straps or bands being removably secured to one another.

Further, the perimeter of the door covering device also includes additional sealing means for allowing the perimeter to be sealed about the hinge hardware used to hang the door. This is the tertiary means for protecting the door. This tertiary sealing means likewise allows the use of hook and loop fastening capabilities, such as a VELCRO® fastener, about the hinge hardware.

The foregoing and other features of the present invention will be apparent from the detailed description that follows.

### BRIEF DESCRIPTION OF THE DRAWINGS

FIG. 1 is a perspective view of a door with which the reusable door covering device of the present invention would be used, the door being shown closed and the door covering device being shown folded in a pre-use condition.

FIG. 2 is a perspective view of the door shown in FIG. 1 and showing the reusable door covering device of the present invention as used with the door, the door being shown in a slightly opened position.

FIG. 3 is a perspective view of the door shown in FIGS. 1 and 2 and showing the reusable door covering device fully attached to the door and the door being closed within the door jamb.

FIG. 4 is a rear elevational view of the door and showing an enlarged portion of a stretching stitch used in the perimeter of the reusable door covering device of the present invention.

FIG. 5 is an enlarged view of the perimeter of the reusable door covering device showing the supplemental hinge hardware covering portion of the perimeter prior to securement to the door.

FIG. 6 is a view similar to that of FIG. 5, but showing the perimeter portion at the hinge hardware covering that hardware following securement to the door.

FIG. 7 is a front elevational view of the door and showing the reusable door covering device fully attached to the door, the door closed and a worker spraying the wall surrounding the door.

### DETAILED DESCRIPTION

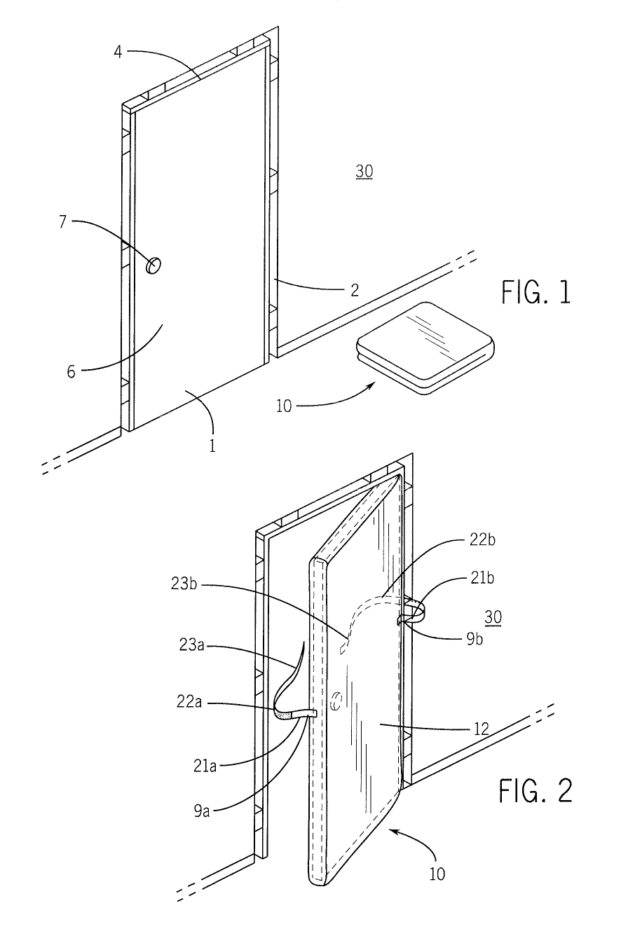

Referring now to the drawings in detail wherein like numbers represent like elements throughout, FIG. 1 illustrates a perspective view of a door, generally identified 1, and a reusable door covering device, generally identified 10, as it would be configured in accordance with the present invention. In FIG. 1, the reusable door covering device 10 is shown as a folded and compact object that takes up little space on a construction site.

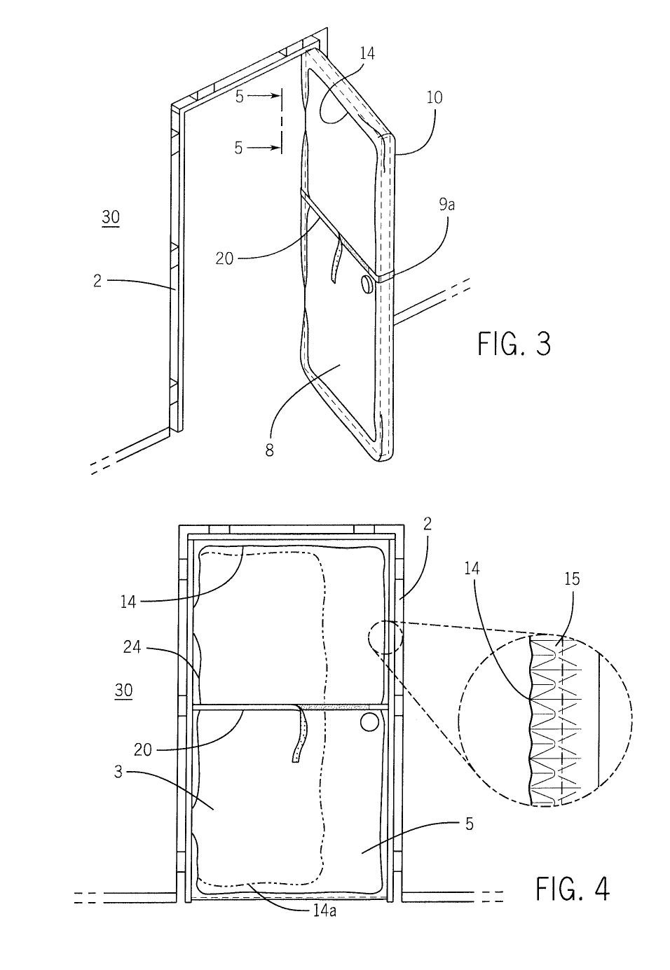

Referring now to FIGS. 2 and 3, they show the reusable door covering device 10 which is comprised of a continuous sheet of material 12 having a perimeter 14. The length of that perimeter 14 is expandable by means of an elastically expandable stitching 15 (see FIG. 4) such that the door covering device 10 can wrap itself about the door 1 while the door 1 remains attached to the door jamb 2. That is, the perimeter 14 can be expanded to the point that the perimeter 14 is slightly greater than the perimeter 4 of the door 1 such that the door covering device 10 can be pulled over the door 1 to cover its front face 6. This allows the door covering device 10 to be used with a wide variety of door sizes. The elastically expandable perimeter 14 also contracts to shorten the length of the perimeter 14. In this way, the perimeter 14 of the device 10 actually extends further inwardly to cover more of the door 1, the extended perimeter 14a being dependent on the size of the door 1 and the size of the device 10. The rear face 8 of the door 1 is only partially covered by the door covering device 10 as shown in FIGS. 3 and 4. Again, this is due to the fact that the elastically expandable perimeter 14 can be expanded to lengthen the perimeter 14 and contracted to shorten the length of the perimeter 14 one the device 10 overwraps the door 1. It should also be noted that the door 1 further comprises a hinged side 3 and an opposing latch side 5. The latch side 5 is that side of the door 1 which typically comprises the door knob (not shown) that is secured within a door hole 7. During use of the device 10, this door knob would be covered by the device.

To prevent the passage of forced air into the space between the door 1 and the reusable door covering device 10, such as when the surrounding walls 30 are being spray painted, the paint being deposited by pressurized air, the door covering device 10 of the preferred embodiment further comprises a band of material 20 which can be used to secure at least two points 9a, 9b of the perimeter 14 of the door covering device 10 on the rear face 8 of the door 1. It is to be understood that multiple bands 20 could also be used with the door covering device 10 of the present invention.

The band of material 20 can be formed as two pieces of strap or band material 22a, 22b each having a first end 21a, 21b, respectively, that is anchored to the door covering device 10 at the perimeter points 9a, 9b. Each piece of strap or band material 22a, 22b further comprises a second end 23a, 23b, the second ends 23a, 23b having complementary hook and loop fastening capabilities, such as by using VELCRO® as mentioned above. In an alternative embodiment, a single band or strap 20 can be used with an anchoring point (not shown) attached directly to the opposite side of the door covering device perimeter 14. Both embodiments would work to prevent the door hinge side of the reusable door covering device 10 from lifting up during spraying as the door hinges, to some extent, prevent the device 10 from fully wrapping around the door 1.

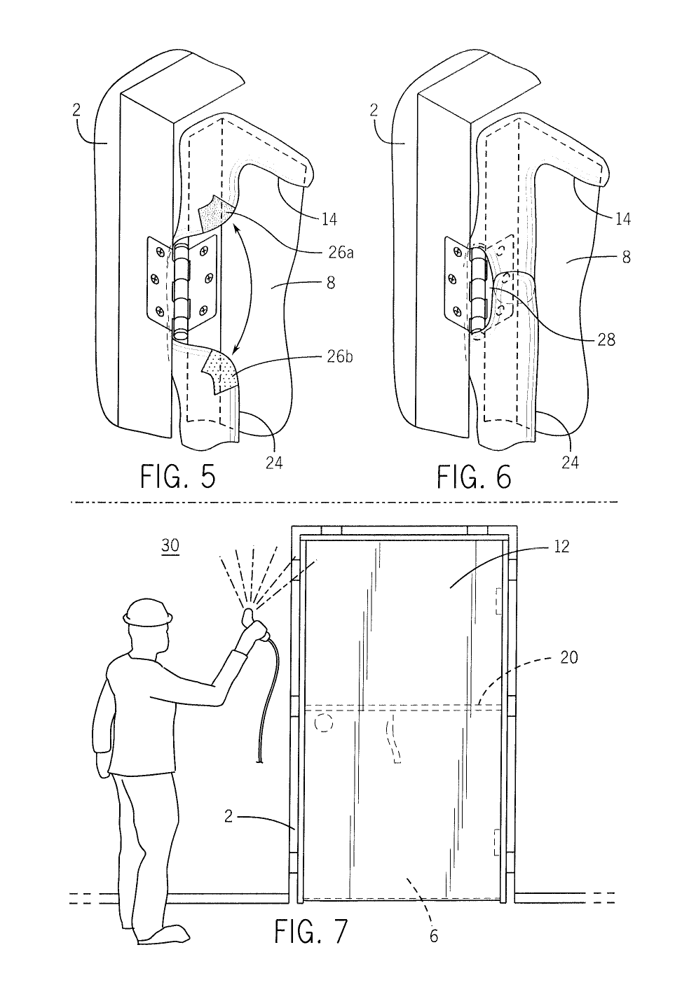

Also to prevent the passage of forced air into the space between the door 1 and the hinge-side perimeter 24 of the reusable door covering device 10, and specifically at the points where the hinge hardware is, additional securement means is provided. As shown in FIGS. 5 and 6, it will be seen that a portion of that perimeter 24 comprises fasteners 26a, 26b. When these complementary fasteners 26a, 26b are secured to one another, that portion of the perimeter 24 creates a tightly-fitted wrap around portion 28 the hardware. Any number of such fasteners 26a, 26b can be used, depending on whether the door 1 is hung with two or more hinges.

In application, the reusable door covering device 10 would be opened from its folded condition shown in FIG. 1. A portion of the reusable door covering device 10 would then be placed over a portion of the door 1. The remaining portion of the device 10 would be slipped over the edges of the door perimeter 4. This would then allow the sheet 12 to fully cover the outer face 6 of the door 1.

To tighten the perimeter 14 of the device 10 about the door 1, the straps 22a, 22b would be pulled—one from the hinge side 3 of the door 1 and one from the latch side 5 of the door 1. The ends 23a, 23b of the straps 22a, 22b would then overlap and secured to one another using hook and loop structure. Further, the supplemental fasteners 26a, 26b would be secured about the hinge hardware of the door 1 to create a tightly-fitted wrap around portion 28 that hinge hardware. It is to be understood that these last two steps could be done by the user in reverse order, i.e. using the supplemental fasteners 26a, 26b first and then securing the straps 22a, 22b.

The door 1 would then be closed, as shown in FIGS. 4 and 5, and spraying of the surrounding walls 30 using a sprayer 40 would deposit droplets of paint or other material onto the walls 30, but not onto the front face 6 of the door 1. When spraying is completed, the device 10 can be removed and placed onto another door for the same type of protection during wall treatment.

The details of the invention having been disclosed in accordance with the foregoing, we claim:

1. A door covering device comprising:
a sheet of protective material;
a perimeter about the sheet of protective material; and
the perimeter being expandable;
wherein the door has a perimeter and a face; and
wherein the perimeter of the sheet of protective material is expandable to be greater than the perimeter of the door such that the sheet of protective material fits over the door and then wraps the sheet about the door to protect the door face.

2. The door covering device of claim 1 further comprising a band of material secured at two points of the perimeter of the sheet of protective material.

3. The door covering device of claim 2 wherein the band comprises two pieces of band material, each piece having a first end attached to a point at the perimeter of the sheet of protective material and each having a second end, the second ends being attached to one another.

4. The door covering device of claim 3 wherein the second ends comprise complementary hook and loop fastening means.

5. The door covering device of claim 1 wherein the perimeter of the sheet comprises elastically expandable stitching that allows the length of the perimeter to be lengthened when expanded and shortened when contracted.

6. The door covering device of claim 1 wherein the device is reusable with other doors.

7. For use with a door having a front door face, a rear door face and a door perimeter, the door further being pre-hung within a door jamb via a plurality of hinges, a reusable door covering device that comprises a sheet of protective material comprising an elastically expandable perimeter, the perimeter of the sheet being expandable to a point that the length of the sheet perimeter is greater than the perimeter of the pre-hung door and shortened by contraction of the perimeter such that the sheet can be wrapped about the door to fully cover the front face of the door and to partially cover the rear face of the door.

8. The reusable door covering device of claim 7 further comprising a band of material secured at two points of the perimeter of the sheet at the rear face of the door when the sheet is wrapped about the door.

9. The reusable door covering device of claim 8 wherein the band comprises two pieces of band material, each piece having a first end attached to a point at the perimeter of the sheet of protective material and each having a second end, the second ends being attached to one another.

10. The reusable door covering device of claim 9 wherein the second ends comprise complementary hook and loop fastening means.

11. The reusable door covering device of claim 7 wherein the perimeter of the sheet comprises elastically expandable stitching that allows the length of the perimeter to be lengthened when expanded and shortened when contracted.

12. The reusable door covering device of claim 7 further comprising additional complementary fasteners in the perimeter of the sheet to create a tight fit of around door hardware.

13. The reusable door covering device of claim 12 wherein the door hardware comprises the plurality of door hinges.

14. A method of protecting a door having a front door face, a rear door face and a door perimeter, the door further being pre-hung within a door jamb via a plurality of hinges, comprising the steps of:
providing a reusable door covering device that comprises a sheet of protective material
providing the sheet of protective material with an elastically expandable perimeter, the perimeter of the sheet being expandable to a point that the length of the sheet perimeter is greater than the perimeter of the pre-hung door and shortened by contraction of the perimeter such that the sheet can be wrapped about the door to fully cover the front face of the door and to partially cover the rear face of the door;
expanding the elastically expandable perimeter such that the perimeter fits over the perimeter of the door;
contracting the elastically expandable perimeter such that the perimeter completely fits over the front door face and partially fits over the rear door face.

15. The method of claim 14 further comprising the step of providing a band of material secured at two points of the perimeter of the sheet at the rear face of the door when the sheet is wrapped about the door.

16. The method of claim 15 wherein the band comprises two pieces of band material, each piece having a first end attached to a point at the perimeter of the sheet of protective material and each having a second end, the second ends being attached to one another.

17. The method of claim 16 wherein the second ends comprise complementary hook and loop fastening means.

18. The method of claim 17 wherein the perimeter of the sheet comprises elastically expandable stitching that allows the length of the perimeter to be lengthened when expanded and shortened when contracted.

19. The method of claim 18 further comprising additional complementary fasteners in the perimeter of the sheet to create a tight fit of around door hardware.

20. The method of claim 19 wherein the door hardware comprises the plurality of door hinges.
